(19) United States
(12) Patent Application Publication
(10) Pub. No.: US 2020/0175894 A1
(43) Pub. Date: Jun. 4, 2020

(54) LABEL WITH REMOVABLE COMPONENT(S)

(71) Applicant: lconex LLC, Duluth, GA (US)

(72) Inventors: Roger Francoeur, Bennington, NE (US); Timothy Darren Livingston, Corryton, TN (US); Robert L. Shinkle, II, Peachtree Corners, GA (US); Shane Lamb, Morristown, TN (US); Matthew Vied, Lexington, KY (US)

(21) Appl. No.: 16/207,589

(22) Filed: Dec. 3, 2018

(51) Int. Cl. G09F 3/00

(52) U.S. Cl. CPC G09F 3/0288

(57) ABSTRACT

A label with one or more removable components is provided. The label includes a substrate having a front side and a back side. A first area is defined within the front side and the back side of the substrate. A second area is defined within the front side and the back side of the substrate, the second area representing an independent-removable label from the label. In an embodiment, a method of printing the label with one or more removable components is provided. Print data is identified as confidential data and non-confidential data. The print data is reformatted so that the confidential data is imaged/printed by a printer in just the second area of the front side representing the independent-removable label.

### BACKGROUND

The ubiquitous label is available in a myriad of configurations for use in various applications, including specialty applications. A label can be imaged on a single side or both sides using inkjet printers, laser printers, and/or thermal printers.

Once imaged with custom information, a label is typically affixed to a package, container, bottle, or other item. In some instances, the custom information may include confidential or sensitive information of a consumer.

As an example, consider a consumer prescription that is imaged with the consumer's private information, such as name, address, medication type, dosage amount, etc. When the consumer is finished with his/her prescription, the prescription container is generally thrown away and not recycled because of label having the consumer's private information. Security-conscious consumers may use a marker to blot out their private information on the labels before discarding of their empty prescription bottles, which is inconvenient to these consumers. Unconcerned consumers may leave the private information on the discarded bottles, which exposes these consumer to potential identity theft or prescription theft of any refills that may still available with the prescription label still attached on the discarded prescription bottle.

In the pharmaceutical setting, many consumers fail to pick up prescriptions for a variety of reasons or sometimes the pharmacy fills a same prescription twice in error resulting in two prescriptions, only one of which is valid and can be picked up by a consumer. In fact, the volume of unpicked-up prescriptions in the industry is a staggering number.

The Health Insurance Portability and Accountability Act (HIPPA) levies substantial fines against pharmacist and pharmacies if those unpicked-up prescription bottles are recycled or thrown away with the label that includes the consumer's private information. The labels are generally strongly adhered to the prescription bottles because of the HIPPA regulations that the label not be easily separated from the bottle (to prevent labels from falling off the bottles); thus, removal of the label is difficult and usually only partially successful, and when successful the bottle is often damaged in some manner.

As a result, a large volume of these perfectly usable prescription bottles are destroyed, shredded, and thrown away by both pharmacies and consumers. This is not environmental friendly and results in a substantial expense to the pharmacies. Furthermore, consumers that are otherwise inclined to participate in recycling programs typically do not recycle their prescription bottles.

### SUMMARY

In various embodiments, a label with removable components, a roll of labels with removable components, and method of printing a label with removable components are provided.

According to an embodiment, a label combination with removable components is provided. The label includes: a substrate having a front side and a back side, a first area defined on the front side, and a second area defined on the front side, wherein the second area representing an independent-removable label from the label.

In an embodiment, a method of printing a label with removable components is provided. A print job includes print data associated with fields defined by a print media type for print media being processed through a printer. Print data that follows fields, which are associated with confidential data within the print data, are reformatted as reformatted print data, ensuring that the confidential data present in the print data are positioned to be imaged/printed on the print media associated with the print media type on an independent-removable label of the print media. The print job with the reformatted print data is provided to a print driver for printing on the print media with the confidential data imaged/printed on just the independent-removable label of the print media.

### BRIEF DESCRIPTION OF THE DRAWINGS

FIG. 1A is a diagram of a label with removable components, according to an example embodiment.

FIG. 1B is a diagram of a label with removable components and depicting imaged areas having different types of customized indicia, according to an example embodiment.

FIG. 1C is a diagram of a back side of a label with removable components, according to an example embodiment.

FIG. 1D is a diagram of label with two removable components, according to an example embodiment.

FIG. 1E is a diagram of another label with two removable components, according to an example embodiment.

FIG. 2 is a diagram of a roll of labels having removable components, according to an example embodiment.

FIG. 3 is a diagram of a method for printing/imaging a label with removable components.

### DETAILED DESCRIPTION

As will be described more completely herein and below, a label with at least one removable components is presented. The label with removable components includes two separate distinct imaging/printing areas on a front side of the substrate that comprises the label. Confidential indicia (information) is imaged/printed in the area associated with the removable component of the label whereas non-confidential indicia is imaged/printed in an area that is not associated with the removable component.

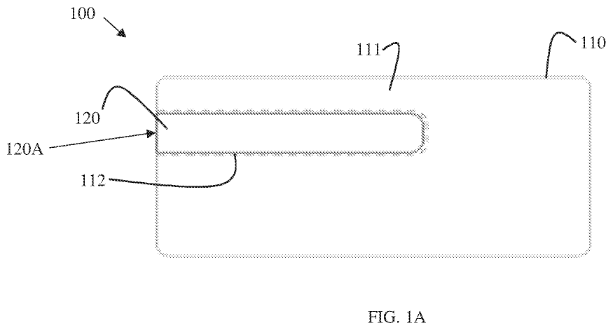

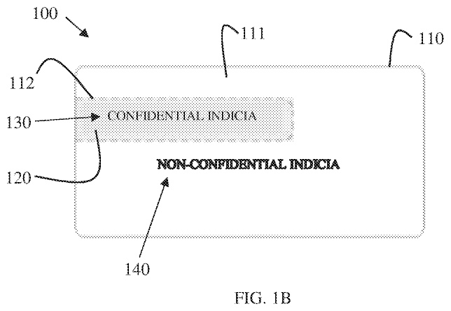

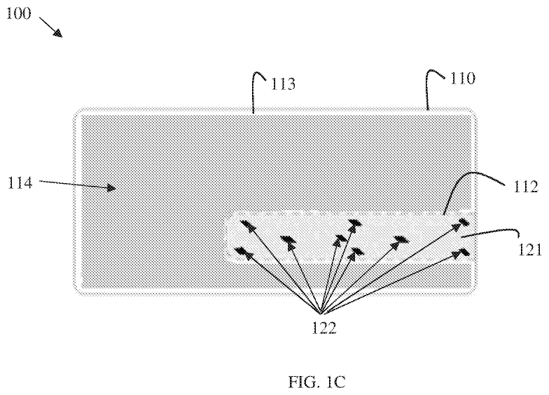

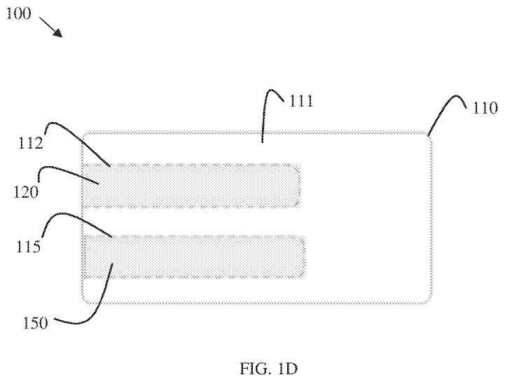

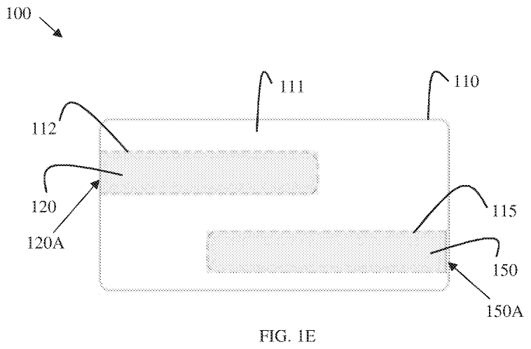

FIG. 1A is a diagram of a label 100 with removable component 120, according to an example embodiment.

The label with the removable component (herein after just “label 100”) includes: a substrate 110, a front side 111, a backside 113 (shown in the FIG. 1C), a manufactured perforation 112, and a removable component 120 (hereinafter “independent-removable label 120”).

In an embodiment, the front side 111 of the substrate 110 includes a thermal-print coating (layer), such as a direct-thermal print coating and/or a thermal-transfer print coating. This allows the label 100 and the independent-removable label 120 to be custom imaged/printed by a terminal print head or a thermal-transfer ribbon of a thermal printer.

In an embodiment, the front side 111 of the substrate includes no special coating for thermal-based imaging/printing and is imaged/printed by an inkjet printer or a laser printer.

In an embodiment, the dimensions of the label 100 and the independent-removable label 120 are the same as conventional pharmaceutical prescription labels; however, unlike conventional labels, the independent-removable label 120 is removable and separable from the label 100 and the image/print area of independent-removable label 120 is sufficient enough to contain all HIPPA information for a consumer prescription.

In an embodiment, the dimensions of the label and the independent-removable label 120 can be custom manufactured based on an application need for self-containing private or sensitive information within just the area presented by the independent-removable label 120.

The term “channel” is a die cut portion of a substrate defined by a weakened periphery that outlines the portion (perforation) within the substrate 110. A “die cut” may be used herein synonymously with the term “perforation.” The area defining the independent-removable label 120 is surrounded by manufactured perforation 112.

Notably, one complete edge 120A of the independent-removable label 120 shares a smaller portion of one edge of the substrate 110. This provides a location on the substrate 110 from which the complete edge 120A of the independent-removable label 120 can be lifted up and pulled in the direction of the opposing edge of the independent-removable label 120 along the perforation 112 to separate the independent-removable label 120 from the substrate 110.

In an embodiment, a portion of a back side 121 (shown in the FIG. 1C) of the independent-removable label 120 along the complete edge 120A is devoid of any adhesive or includes an adhesive deadener applied over adhesive. This allows the one complete edge 120A of the independent-removable label 120 to be lifted with ease and acquired as a tab 120A for removing the independent-removable label 120 from the substrate 110.

Furthermore, the independent-removable label 120 is offset from the top and the bottom of the label 100 to provide structural integrity the label 100 and the independent-removable label 120 during removal of the independent-removable label 120 from the substrate 110.

During user application, the label 100 is fed through a printer (direct thermal, thermal transfer, inkjet, or laser) and print driver software along with user-application software control the print job such that confidential information is wholly contained on the front side 111 within and on the independent-removable label 120. Furthermore, non-confidential information is wholly contained on the front side outside of and not on any portion of the independent-removable label 120.

In an embodiment, the printer may also activate an adhesive layer provided on the backside 113 of the substrate.

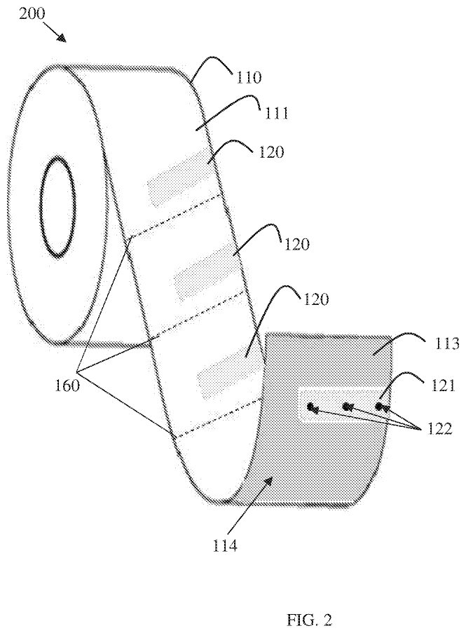

In an embodiment, the printer may also provide a cutting mechanism from which the label 100 imaged with the confidential and non-confidential information can be separated from a roll 200 (shown in the FIG. 2) of labels 100 loaded into the printer.

In an embodiment, the label 100 imaged with the confidential and non-confidential information is applied to a prescription bottle/container when fulfilling a consumer's prescription. If the prescription was a duplicate prescription filled in error by a pharmacy, or if the prescription is never picked up by the consumer, staff of the pharmacy grabs edge 120A and separates the independent-removable label 120 from the bottle and from a remaining portion of the label 100 that remains affixed to the bottle and shreds or destroys the independent-removable label 120. The bottle can then be recycled by the pharmacy and/or reused by the pharmacy to fulfill a different consumer's prescription (after the medicine is restocked from the original prescription bottle). When a consumer picks up the prescription and is finished with the medicine, the consumer grasps end 120A separates the independent-removable label 120; destroys or disposes of the independent-removable label 120, and can recycle the bottle.

The label 100 permits reuse and recycling of containers, bottles, or items that have confidential or sensitive information originally printed on the label 100. This is done by providing the independent-removable label 120 and containing the confidential or sensitive information during print application to just the independent-removable label 120, such that the confidential or sensitive information can be easily separated from the label 100 already adhered to a bottle, container, or item by separating and removing the independent-removable label 120; disposing or destroying the independent-removable label 120; and reusing or recycling the bottle, container, or item with only non-confidential or non-sensitive information remaining on the label 100 after removing the independent-removable label 120

FIG. 1B is a diagram of a label 100 with removable components 120 and depicting imaged areas 130 and 140 having different types of customized indicia, according to an example embodiment.

The FIG. 1B illustrates that confidential indicia 130 (such as defined by government regulations (e.g., HIPPA, etc.) or defined by privacy agreements with consumers) is wholly and exclusive contained on the front side 111 of the independent-removable label 120. Additionally, non-confidential indicia 140 is all that is provided on the remaining portion of the front side 111 of the label 100 (the remaining portion representing the label 100 without the independent-removable label 120).

The printer software is customized and/or the printer driver software is customized to categorize indicia 130 and 140 into types of confidential and non-confidential. The customized software ensures (based on the font sizes, font types, and dimensions associated with the independent-removable label 120 and the label 100) that when a confidential data type is detected during a print job, the confidential indicia 130 is printed/imaged on just the independent-removable label 120 by the printer and that only non-confidential indicia 140 is printed/imaged on the portions of the label 100 that do not include the independent-removable label 120.

It is to be noted that the customized software may permit non-confidential indicia 140 to be imaged/printed on the independent-removable label 120 but the customized software does not permit any confidential indicia 130 to be imaged/printed anywhere outside of the independent-removable label 120 on the label 100. That is, a print job having confidential indicia 130 is only permitted to be imaged on the independent-removable label 120.

FIG. 1C is a diagram of a back side 113 of a label 100 with removable components 120, according to an example embodiment.

The back side 113 of the substrate 100 includes an adhesive coating 114. A portion of the back side 113 corresponds to the independent-removable label 120 (represented as back side 121).

The adhesive coatings 122 on the back side 121 of the independent-removable label 120 can be achieved in a variety of different manners. For example, one or more strips of adhesive 122 can be applied as patches on the back side 121. It is noted that although several small adhesive patches 122 are illustrated in the FIG. 10, the embodiments of the invention are not to be limited to that specific arrangement and this was presented for purposes of illustration.

Thus, in an embodiment, the back side 121 may include a single strip or patch of adhesive 122. In an embodiment, the single patch of adhesive 122 is substantially centered on the back side 121.

In an embodiment, the back side 121 includes two to four strips or patches of adhesive 122 situated along the edges of the back side 121.

In an embodiment, the back side 121 includes an adhesive deadener applied over an initial adhesive coating 114. In an embodiment, the adhesive deadener is applied in patches over the adhesive coating 114.

In an embodiment, the back side 121 is substantially devoid of any adhesive. By “substantially” it is meant that there is either no adhesive or a very small configured amount of adhesive relative to an overall area of the back side 121.

The back side 121 includes one of: no adhesive, a small amount of strategically placed adhesive patches 122, and a uniform coating of adhesive that includes adhesive deadener applied there over. This makes the adhesive bond between the back side 113 and an item to which it is affixed stronger than the adhesive bond between the back side 121 and the item (in the area defined by the independent-removable label 120). Thus, removal of the independent-removable label 120 using tab 120A is more easily achieved.

FIG. 1D is a diagram of label 100 with two removable components 120 and 150, according to an example embodiment.

The two independent-removable labels 120 and 150 are sufficiently spaced apart within the label 100 to provide structure integrity to the label 100 when each of the independent-removable labels 120 and 150 are separated from the substrate 110.

The two independent-removable labels 120 and 150 are illustrated as having a same orientation and same dimensions. It is noted that this does not have to be the case as illustrated in the FIG. 1 E where the tabs 120A and 150A for removal of the two independent-removable labels 120 and 150 are on different ends of the substrate 110.

It is also to be noted that the sizes and/or dimensions of each of the two independent-removable labels 120 and 150 can be different from one another and do not have to be substantially the same as illustrated in the FIGS. 1D and 1E.

Furthermore, in an embodiment, the label 100 includes more than two independent-removable labels 120 and 150.

In an embodiment, each of the multiple labels 120 and 150 of label 100 are controlled by printer software and/or printer driver software to include only confidential indicia 130 during print jobs.

In an embodiment, just one of the multiple labels 120 or 150 are controlled by printer software and/or printer driver software to include confidential indicia 130 while another of the multiple labels 120 or 150 is controlled by the printer software and/or printer driver software to include a specific additional user-defined type of non-confidential data. Here, if the application dictates a user-defined type of non-confidential indicia 140 may be imaged on one of the independent-removable labels 120 or 150 and separated as label 120 or 150 for a desired purpose.

FIG. 2 is a diagram of a roll 200 of labels 100 having removable components 120, according to an example embodiment.

The roll 200 may include additional perforations 160 to allow for individual separation of each label 100 from the roll 200 following printing by a printer.

In an embodiment, the additional perforations 160 are rather sense marks that identify to a printer during a print job a separation between labels 100 of the roll.

In an embodiment, the roll 200 includes no additional perforations beyond perforation 112 and the roll 200 includes no additional sense marks; rather, the print job dictates to the printer where one label 100 that was printed on is to be variably separated from the roll 200 following the printing.

The roll 200 includes a web or single sheet of substrate 110. The front side 111 is either coated with a print coating to support thermal printing (direct thermal coating or thermal transfer coating) or includes no special coating (inkjet or laser-based printing). Each label 100 identified in the roll 200 includes the independent-removable label 120.

The back side 113 of the substrate 110 includes an adhesive coating 114 whereas the back side 121 of each independent-removable label 120 includes adhesive patches 122 or adhesive deadener applied over an adhesive coating.

In an embodiment, the front side 111 includes a release coating to allow separation of the substrate 110 when unwound from the roll 200.

In an embodiment, the backside 113 includes a release coating to allow separation of the substrate 110 when unwound from the roll 200.

The roll 200 is configured in size and dimension to be inserted into a printer (pharmaceutical or receipt printer that is direct thermal, thermal transfer, inkjet, or laser). The leading edge of the roll 200 is fed through an infeed mechanism of the printer and loaded as print media into the printer.

During operation of the printer, print jobs are executed by printer software and the printer driver. The printer software and/or printer driver are customized with specialized programming to identify at least two types of data that is being imaged on the front side 111 of the individual labels 100. The two types of data include confidential data and non-confidential data. The customized programming performs the necessary alignments within the printer driver to ensure that no confidential indicia 130 is imaged/printed on the label 100 in an area that is outside the independent-removable label 120. That is, the customized programming only permits confidential data (based on data types identified in the print job) to be imaged on the independent-removable label 120.

In an embodiment, field-identifiers or descriptors are mapped in a table to either be confidential or non-confidential. The customized programming uses the table to determine that the data that follows the field or descriptor in the print job is confidential or non-confidential. Any data following a field or descriptor mapped in the table to confidential is formatted and aligned such that the print driver locates and causes that data to be imaged or printed on the independent-removable label 120.

In an embodiment, the field-identifiers or descriptors assigned to the confidential data type within the table is defined based on HIPPA requirements. In an embodiment, the field-identifiers or descriptors assigned to the confidential data type within the table include: name, address, data of birth, age, phone number, fax number, email, health plan number, medical diagnosis or medical diagnosis code, and social security number.

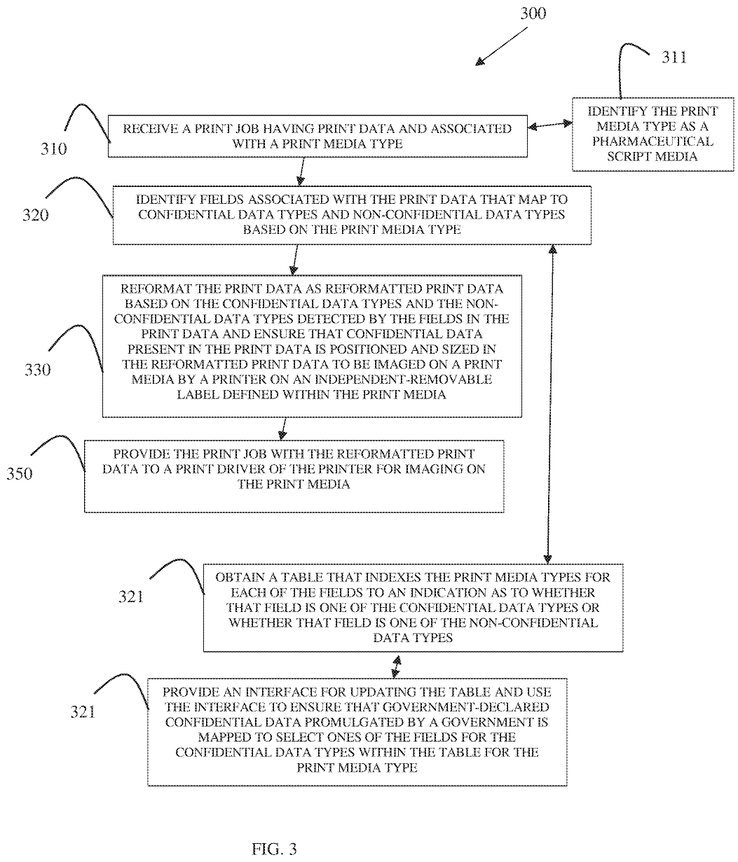

FIG. 3 is a diagram of a method 300 for printing/imaging a label with removable components. The method 300 (referred to herein as a “confidential print manager”) is implemented as executable instructions that reside within a non-transitory computer-readable storage medium of a device. A hardware processor of the device executes the confidential print manager from the non-transitory computer-readable storage medium.

In an embodiment, the device that executes the confidential print manager is a printer.

In an embodiment, the device that executes the confidential print manager is a computer or computer device.

In an embodiment, the confidential print manager represents a modified version of an existing pharmaceutical printing application or service.

In an embodiment, the confidential print manager represents a modified version of an existing print driver for a printer.

In an embodiment, the confidential print manager represents modifications to an existing pharmaceutical printing application or service and an existing print driver.

In an embodiment, the confidential print manager performs the processing described above with respect to the customized programming associated with print jobs for a printer utilizing the roll 200 and the label 100.

At 310, the confidential print manager receives a print job having print data and associated with a print media type. The print media type identifies the size, dimensions, and stock of a particular print media. Herein, the print media type is the label 100 with independent-removable label 120 as discussed above.

According to an embodiment, at 311, the confidential print manager identifies the print media type as a pharmaceutical script print media.

At 320, the confidential print manager identifies fields associated with the print data that map to confidential data types and non-confidential data types based on the print media type. That is, data that is printed on the print media type includes predefined types of data, such each different type of data identified by a field. It is noted that the field can be positioned-based within the data and not actual present in the print data, such that the name appears in byte positions 0-20, address appears in byte positions 21-60, etc.

In an embodiment, at 321, the confidential print manager obtains a table that indexes available print media types for each of the fields to an indication as to whether that field is one of the confidential data types of whether that field is one of the non-confidential data types. The table retains the mapping, such that it can be searched on field identifiers and media type and provide the indication.

In an embodiment of 321 and at 322, the confidential print manager provides an interface for updating the table and uses the interface to ensure that government-declared confidential data promulgated by a government is mapped to select ones of the fields for the confidential data types within the table for the print media type. In an embodiment, the government-declared confidential data is the HIPPA regulations. In an embodiment, the confidential data can be custom-defined based on privacy agreements between entities and consumers.

At 330, the confidential print manager reformats the print data as reformatted print data based on the confidential data types and non-confidential data types detected by the fields within the print data. The confidential print manager ensures that confidential data present in the print data is positioned and sized in the reformatted print data to be imaged on the print media on an independent-removable label defined within the print media.

In an embodiment, the print media is the label 100 and the independent-removable label is the label 120.

At 340, the confidential print manager provides the print job with the reformatted print data to a print driver of the printer for imaging on the print media with all confidential data imaged only in the area defined on the independent-removable label of the print media.

Although the present invention has been described with particular reference to certain preferred embodiments thereof, variations and modifications of the present invention can be effected within the spirit and scope of the following claims.

1. A label, comprising:
a substrate having a front side and a back side;
a first area defined on the front side; and
a second area defined on the front side and the back side representing a removable-independent label from the label, wherein the back side includes a uniform coating of adhesive and wherein an edge back side of the back side corresponding to an edge of the second area includes an adhesive deadener applied over the corresponding adhesive that permits the edge of the second area to be grasped, lifted, and separated from the first area.

2. The label of claim 1, wherein the front side includes a thermal-print coating selected from: a direct thermal print coating and a thermal transfer print coating.

3. The label of claim 1, wherein the thermal-print coating includes a release coating applied over top of the thermal print coating.

4.-9. (canceled

10. The label of claim 1, wherein second area is outlined by a die cut perforation made through the substrate.

11. The label of claim 10, wherein the edge of the second area is part of a substrate edge of the substrate, wherein the edge is a pull tab to remove the independent-removable label from the substrate.

12. The label of claim 1 further comprising:
a third area defined on the front side and the back side representing a second removable-independent label from the label.

13. A label roll, comprising:
a web or continuous sheet of a substrate;
labels defined within the substrate;
each label including a first area defined on the front side and the back side of the substrate and a second area defined on the front side and the back side of the substrate, wherein the second area representing an independent-removable label for the corresponding label, wherein the back side includes a uniform coating of adhesive, and wherein an edge back side for an edge of the independent-removable label and along the corresponding back side of the edge includes an adhesive deadender applied over the corresponding adhesive that permits the edge of the second area to be grasped, lifted, and separated from the first area.

14. The label roll of claim 13, wherein each second area die cut as a perforation through the substrate.

15. The label roll of claim 13, wherein each independent-removable label having the edge that shares a portion of a substrate edge of the substrate, the edge defining a pull tab to remove that independent-removable label from the corresponding label.

16. The label roll of claim 13, wherein each label including a third area defined on the front side and the back side of the substrate, wherein the third area representing a second independent-removable label for the corresponding label.

17.-20. (canceled)
